(19) United States
(12) Patent Application Publication
(10) Pub. No.: US 2003/0098289 A1
(43) Pub. Date: May 29, 2003

(54) Forming an optical mode transformer

(76) Inventors: Dawei Zheng, Los Angeles, CA (US); Yiqiong Wang, San Marino, CA (US); Dazeng Feng, Arcadia, CA (US); Xiaoming Yin, Pasadena, CA (US)

Correspondence Address: Travis Dodd, 2490 Heyneman Hollow, Fallbrook, CA, 92028, US

(21) Appl. No.: 09/998,378

(22) Filed: Nov. 29, 2001

(51) Int. Cl. C03C 15/00

(52) U.S. Cl. 216/24; 216/33; 216/41; 216/67; 216/72; 216/79; 216/80

(57) ABSTRACT

A method of forming an optical component is disclosed. The method includes obtaining an optical component precursor having a first medium positioned over a base and converting a portion of the first medium to a second medium. The method further includes removing a portion of the second medium so as to form a ridge in the second medium. The portion of the second medium is removed so as to expose a portion of the first medium.

### 1. FIELD OF THE INVENTION

The invention relates to one or more optical networking components. In particular, the invention relates to an optical mode transformer.

### 2. BACKGROUND OF THE INVENTION

Optical networks employ a variety of optical components such as switches, demutiplexers and attenuators. Each optical component typically includes one or more waveguides for carrying the light signals to be processed by the optical component. These waveguides are often coupled to an optical fiber in communication with an optical network.

The cross section of the waveguide on an optical component is often smaller than the cross section of the optical fibers. As a result, the optical fibers typically have a larger space available for carrying of a light signal than is available in the waveguides optical component. Hence, a light signal entering the optical fiber from the waveguide often experiences an abrupt expansion in size. This abrupt size change is often a source of optical loss. The optical loss can result from a change in the number of modes. For instance, the fundamental mode is typically the desired mode for processing by the network. However, when a light signal is abruptly expanded, the higher order modes can be excited. Because the higher order modes are not desired, the portion of light signal traveling in these higher order modes are a source of the optical loss.

Optical components often include a mode transformer configured to reduce the optical loss associated with the transition from an optical fiber to a waveguide. These mode transformers are often fabricated by bonding a piece of silicon to a silicon waveguide. However, the bonding process is often inconsistent and can provide inconsistent optical qualities.

For the above reasons there is a need for an improved mode transformer.

### SUMMARY OF THE INVENTION

The invention relates to a method of forming an optical component. The method includes obtaining an optical component precursor having a first medium positioned over a base and converting a portion of the first medium to a second medium. The method further includes removing a portion of the second medium so as to form a ridge in the second medium.

The method can also include removing a portion of the first medium so as to form a second ridge in the first medium. The second ridge being formed under the first ridge.

The second ridge can be formed under the first ridge. In some instances, the first ridge and the second ridge taper in the same direction and the first ridge tapers to a terminal end.

Removing the portion of the second medium can include performing a first etch and removing the portion of the first medium can include performing a second etch. In some instances, the first etch is selected so as to remove the second medium faster than the first medium. The ratio of the second medium etch rate to the first medium etch rate can include ratios greater than 4:1, 8:1, 15:1, 20:1, or 50:1. In some instances, the second etch is selected so as to remove the first medium faster than the second medium. The ratio of the first medium etch rate to the second medium etch rate can include ratios greater than 4:1, 8:1, 15:1, 20:1, or 50:1.

Another embodiment of the method includes obtaining a wafer having a first medium and converting a preliminary portion of the first medium to a second medium. The method also includes bonding the wafer to a base such that the converted second medium is bonded to the base. The method can further include converting a first portion of the first medium to the second medium such that the first medium is positioned between the preliminary portion and the first portion.

### BRIEF DESCRIPTION OF THE FIGURES

FIG. 1A is a top view of an optical component having a mode transformer. The mode transformer includes a secondary ridge positioned over a primary ridge.

FIG. 1B is a cross section of the optical component shown in FIG. 1A taken at the line labeled A.

FIG. 1C is a cross section of the optical component shown in FIG. 1A taken at the line labeled B.

FIG. 1D is a cross section of the optical component shown in FIG. 1A taken at the line labeled C.

FIG. 1E is a side view of the optical component shown in FIG. 1A taken in the direction of the arrow labeled D.

FIG. 2A is a top view of an optical component having a mode transformer. The mode transformer includes a secondary ridge positioned over a primary ridge and a tertiary ridge positioned over the secondary ridge.

FIG. 2B is a cross section of the optical component shown in FIG. 2A taken at the line labeled A.

FIG. 3A is a top view of an optical component having a mode transformer. The mode transformer is positioned between an expanded waveguide and a contracted waveguide.

FIG. 3B is a cross section of the optical component shown in FIG. 3A taken at the line labeled A.

FIG. 3C is a cross section of the optical component shown in FIG. 3A taken at the line labeled B.

FIG. 3D is a cross section of the optical component shown in FIG. 3A taken at the line labeled C.

FIG. 4A is a top view of an optical component having a mode transformer with a secondary region positioned on a primary region. The secondary region has upper edges that are rounded.

FIG. 4B is a cross section of the optical component shown in FIG. 4A taken at the line labeled A.

FIG. 4C is a cross section of the optical component shown in FIG. 4A taken at the line labeled B.

FIG. 4D illustrates an optical component having a mode transformer with a secondary region positioned on a primary region. The secondary region has upper edges that are rounded. The secondary region tapers to a terminal end that is also rounded.

FIG. 5A through FIG. 5L illustrate a method of forming an optical component with a mode transformer having a secondary ridge positioned on a primary ridge.

FIG. 6A through FIG. 6D illustrate a method of forming an optical component having a mode transformer positioned between an expanded waveguide and a contracted waveguide.

FIG. 7A through FIG. 7H illustrate a method of forming an optical component having a mode transformer with more that two ridges.

FIG. 8A through FIG. 8G illustrate a method of forming an optical component precursor that is suitable for use in fabricating the mode transformer.

### DETAILED DESCRIPTION OF THE PREFERRED EMBODIMENT

The invention relates to a method of forming a mode transformer. The method includes obtaining an optical component precursor having a first medium positioned over a base and converting a portion of the first medium to a second medium. The method also includes performing a first etch so as to remove a portion of the second medium. The first etch forms a first ridge in the second medium. The first ridge defines a first portion of the light signal carrying region of a mode transformer.

The method can further include performing a second etch so as to remove a portion of the first medium. The second etch forms a second ridge under the first ridge formed during the first etch. The second ridge defines a second portion of the light signal carrying region of the mode transformer.

In some instances, the first ridge and the second ridge taper in the same direction. Additionally, the tapering portion of the second ridge can be positioned under at least a portion of the tapering portion of the first ridge. The first ridge can taper from an expanded port to a terminal end and the second ridge can taper from the expanded port to the contracted port of a waveguide. The taper of the first ridge and the taper of the second ridge serve to transform the mode of a light signal traveling from the expanded port to the contracted port.

The first etch and/or the second etch can be selected so as to etch the second medium faster than the first medium. When the first etch etches the second medium at a faster rate than the first medium, the etch slows once the first medium is reached. As a result, the second medium acts as an etch stop. The use of the etch stop can replace a timed etch. The depth uniformity that can be achieved with a timed etch is on the order of 5% while the depth uniformity that can be achieved with an etch stop is on the order of 1%. An improved depth uniformity improves the optical performance of the mode transformer. As a result, employing an etch stop can provide a mode transformer with an improved optical performance.

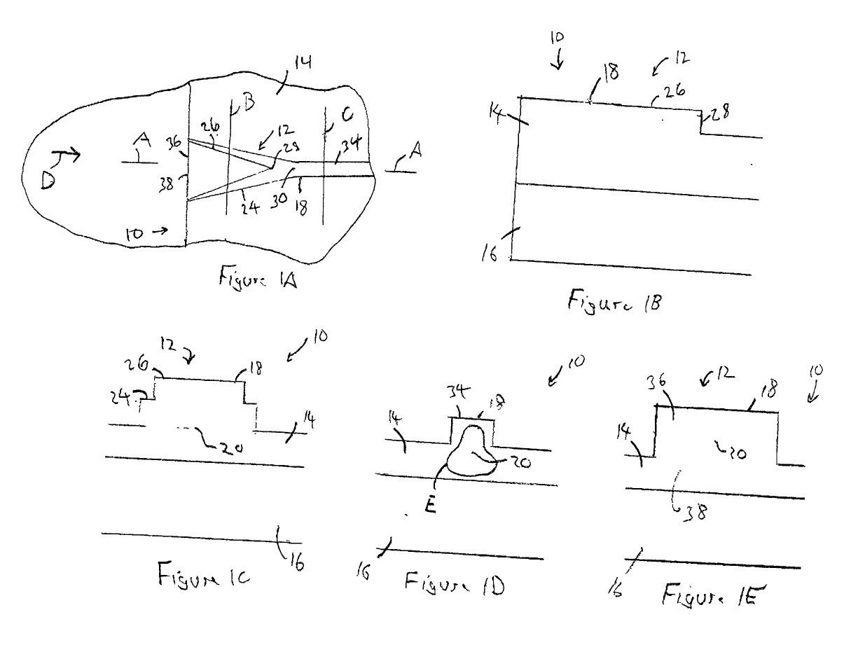

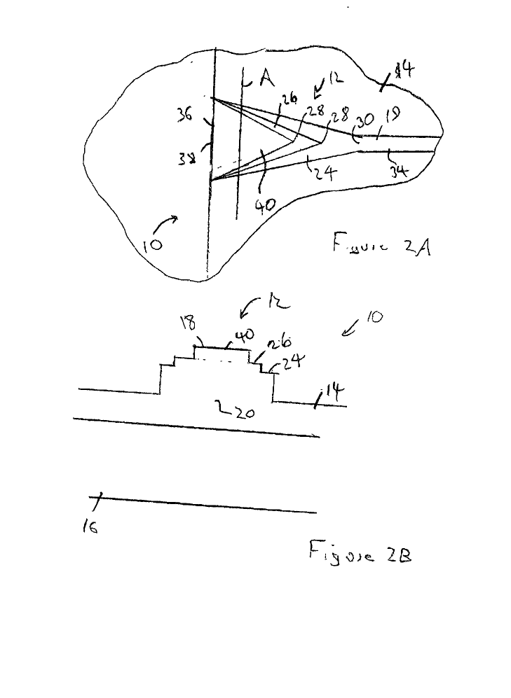

FIG. 1A through FIG. 1E illustrate an optical component 10 having a mode transformer 12. FIG. 1A is a top view of the optical component 10. FIG. 1B is a cross section of the optical component 10 shown in FIG. 1A taken at the line labeled A. FIG. 1C is a cross section of the optical component 10 shown in FIG. 1A taken at the line labeled B. FIG. 1D is a cross section of the optical component 10 shown in FIG. 1A taken at the line labeled C. FIG. 1E is a side view of the optical component 10 shown in FIG. 1A taken in the direction of the arrow labeled D.

The optical component 10 includes a light transmitting medium 14 positioned over a base 16. The light transmitting medium 14 includes a rib 18 that defines a portion of a light signal carrying region 20 where light signals are constrained. Suitable light transmitting media include, but are not limited to, silicon, polymers and silica. The portion of the base 16 adjacent to the light signal carrying region 20 is configured to reflect light signals from the light signal carrying region 20 back into the light signal carrying region 20. As a result, the base 16 also defines a portion of the light signal carrying region 20. The line labeled E illustrates the profile of a light signal carried in the light signal carrying region 20 of FIG. 1D.

Although not shown, a cladding layer can optionally be positioned over the light transmitting medium 14. The cladding layer can have an index of refraction less than the index of refraction of the light transmitting medium 14 so light signals from the light transmitting medium 14 are reflected back into the light signal carrying region 20.

The portion of the rib 18 in the mode transformer 12 includes a secondary ridge 26 positioned on a primary ridge 24. The primary ridge 24 and the secondary ridge 26 taper in the same direction. The secondary ridge 26 tapers to a terminal end 28. The primary ridge 24 tapers to a narrow region 30. At least a portion of the primary ridge extends beyond the narrow region 30 without additional tapering. The portion of the primary ridge 24 beyond the narrow region 30 serves as a contracted waveguide 34.

Although the secondary ridge 26 is not shown as extending beyond the narrow region 30, the secondary ridge can extend beyond the narrow region 30. Further, the secondary ridge 26 is shown as being narrower than the primary ridge 24 along the length of the secondary region, however, all or a portion of the secondary ridge 26 can have the same width as the primary ridge 24 along a portion of the secondary ridge 26 length.

The mode transformer 12 is shown positioned at an edge of the optical component 10. The mode transformer 12 ends at an expanded port 36 that can serve as a facet 38. The size of the facet 38 can approximate the size of an optical fiber so the mode transformer 12 can be coupled with an optical fiber. A light signal traveling from the optical fiber passes through the facet 38. The light signal contracts as it passes through the mode transformer 12. The contracted waveguide 34 receives the light signal through a contracted port. The optical component 10 can be operated in reverse so the mode transformer 12 expands the light signal as the light signal travels from the contracted waveguide 34 to the facet 38.

In some instances, the portion of the rib 18 located in the mode transformer 12 can include more than two ridges. FIG. 2A through FIG. 2B illustrate a mode transformer 12 including three ridges. FIG. 2A is a top view of the mode transformer 12 and FIG. 2B is a cross section of the mode transformer taken in the direction of the line labeled A. The portion of the rib 18 located in the mode transformer 12 includes a primary ridge 24, a secondary ridge 26 and a tertiary ridge 40. The primary ridge 24, the secondary ridge 26 and the tertiary ridge 40 taper in the same direction. The secondary ridge 26 and the tertiary ridge 40 each taper to a terminal end 28. The primary ridge 24 tapers to a contracted waveguide 34.

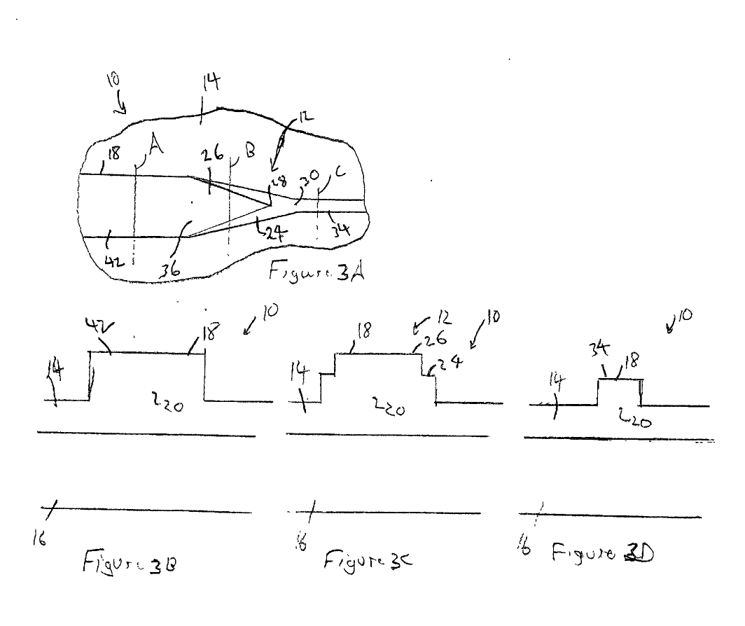

The mode transformer 12 need not be positioned at an edge of the optical component 10 as illustrated in FIG. 3A through FIG. 3C. FIG. 3A is a top view of the optical component 10. FIG. 3B is a cross section of the optical component 10 shown in FIG. 3A taken at the line labeled A. FIG. 3C is a cross section of the optical component 10 shown in FIG. 3A taken at the line labeled B. FIG. 3D is a cross section of the optical component 10 shown in FIG. 3A taken at the line labeled C. The mode transformer 12 is positioned between an expanded waveguide 42 and a contracted waveguide 34. During operation of the optical component 10, a light signal traveling from the expanded waveguide 42 enters the mode transformer 12 through an expanded port 36. The light signal contracts as the light signals travels through the mode transformer 12. The contracted waveguide 34 receives the light signal through the contracted port. The optical component 10 can be operated in reverse so the mode transformer 12 expands the light signal as the light signal travels from the contracted waveguide 34 to the expanded waveguide 42.

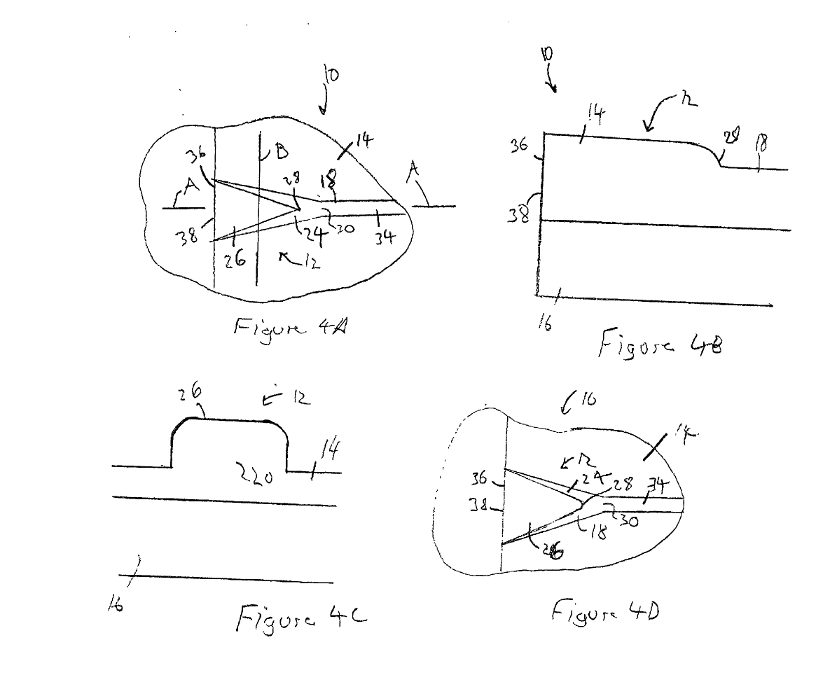

The one or more ridges over the primary ridge 24 can have rounded sides. FIG. 4A through FIG. 4C illustrate a mode transformer 12 having rounded sides. FIG. 4A is a top view of the optical component 10. FIG. 4B is a cross section of the optical component 10 shown in FIG. 4A taken at the line labeled A. FIG. 4C is a cross section of the optical component 10 shown in FIG. 4A taken at the line labeled B. The mode transformer 12 includes a secondary ridge 26 positioned over a primary ridge 24. The secondary ridge 26 has one or more rounded sides. The rounding of the sides can serve to reduce the amount of scattering and/or reflection that can occur as a light signal that travels through the mode transformer 12. Although FIG. 4C shows the entire side of a secondary ridge 26 being rounded, a portion of second ridge side can be rounded. For instance, the upper edges of the side can be rounded.

Although the terminal end 28 of the secondary ridge 26 is shown as being pointed in FIG. 4A, the terminal end 28 can be rounded as illustrated in FIG. 4D. Rounding of the terminal end 28 can serve to further reduce scattering and/or reflection that can occur as a light signal travels through the mode transformer 12.

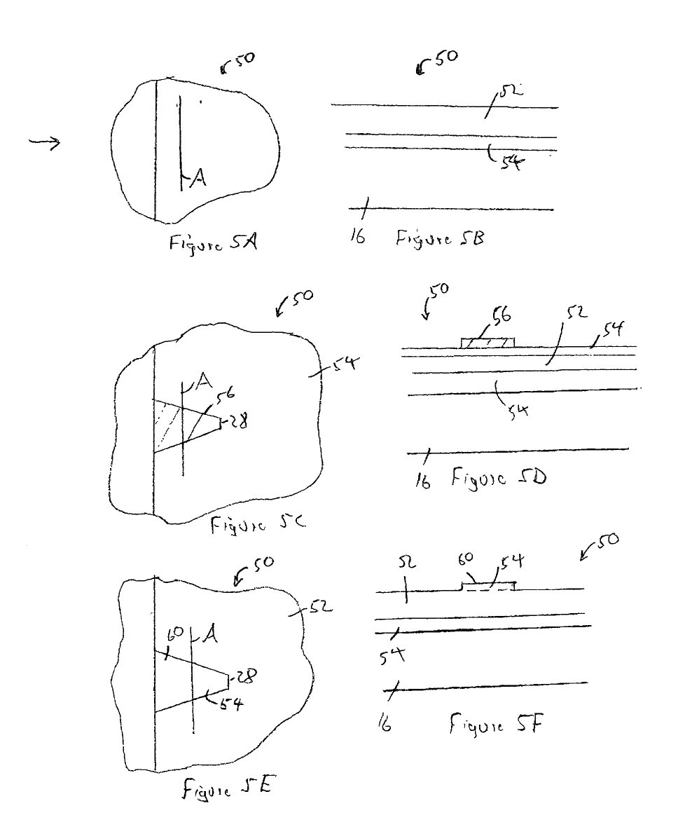

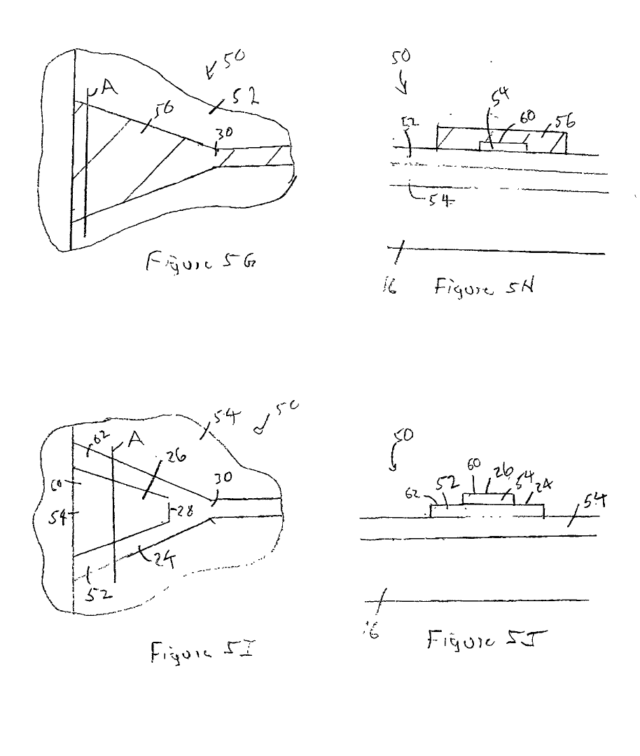

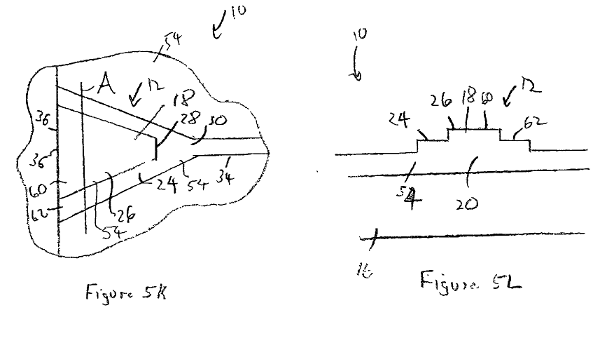

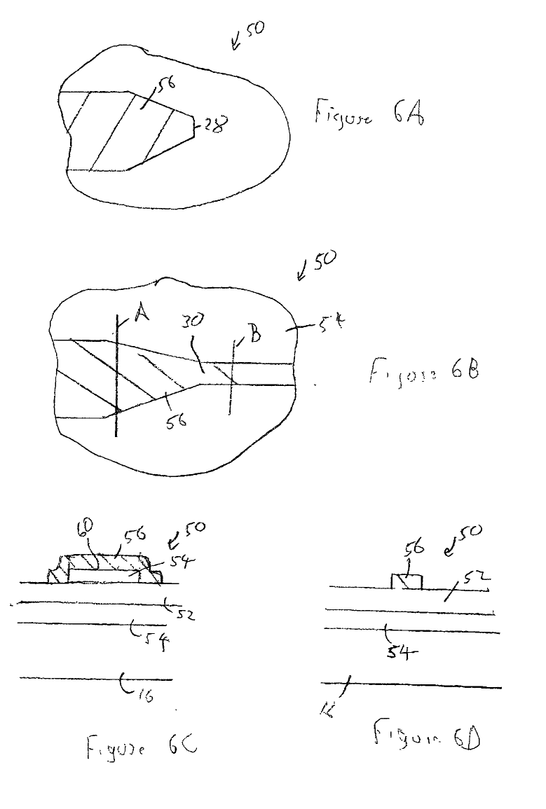

FIG. 5A through FIG. 5L illustrate a method of forming a mode transformer 12. FIG. 5A through FIG. 5B illustrate an example of an optical component precursor 50. FIG. 5A is a top view of the optical component precursor 50 and FIG. 5B is a cross section of the optical component precursor 50 shown in FIG. 5A taken at the line labeled A. The optical component precursor 50 has a first medium 52 positioned over a base 16. A second medium 54 is positioned between the first medium 52 and the base 16. In some instances, the second medium 54 is the light transmitting medium 14. The optical component precursor 50 can be fabricated or can be received from a supplier.

A first portion of the first medium 52 is converted to the second medium 54 to provide the optical component precursor 50 of FIG. 5C and FIG. 5D. FIG. 5C is a top view of the optical component precursor 50 and FIG. 5D is a cross section of the optical component precursor 50 shown in FIG. 5C taken at the line labeled A. As noted above, the second medium 54 can be the light transmitting medium 14. Accordingly, converting the first medium 52 to the second medium 54 can include converting the first medium 52 to the light transmitting medium 14. Converting the first medium 52 to the second medium 54 can include changing the chemical composition of the first medium 52, injecting a material into the first medium 52 and/or changing the structure of the first medium 52.

A suitable first medium 52 includes, but is not limited to, silicon and a suitable second medium 54 includes, but is not limited to, silica. Silicon can be converted to silica by performing a thermal oxidation. A thermal oxidation allows the depth to which silicon is converted to be controlled. Additionally, a thermal oxidation provides a high degree of conversion uniformity.

A first mask 56 is formed on the second medium 54 as shown in FIG. 5C and FIG. 5D. The first mask 56 is formed over the region of the optical component precursor 50 where the secondary ridge 26 is to be formed. The first mask 56 tapers to a terminal end 28. A suitable first mask 56 includes, but is not limited to, photoresist and polyimide.

A portion of the second medium is removed and the first mask 56 removed to provide the optical component precursor 50 shown in FIG. 5E and FIG. 5F. FIG. 5E is a top view of the optical component precursor 50 and FIG. 5F is a cross section of the optical component precursor S0 shown in FIG. 5E taken at the line labeled A. The portion of the second medium is removed so as to form a first ridge 60. As will become evident below, the first ridge 60 serves as the secondary ridge 26 discussed above. In some instances, the portion of the second medium 54 is removed to the level of the first medium 52. Accordingly, the second medium 54 can be removed so as to expose the first medium 52.

A suitable method for removing the portion of the second medium includes, but is not limited to, performing a first etch on the second medium 54. In some instances, the first etch is selected to etch the second medium 54 at a faster rate than the first medium 52. For instance, the first etch can etch silica at a faster rate than silicon. When the first etch etches the second medium 54 at a faster rate than the first medium 52, the etch slows once the first medium 52 is reached. Accordingly, the first etch can be continued beyond when the first medium 52 is first reached without removing a large portion of the first medium 52. Continuation of the first etch can ensure that the portion of the second medium 54 that is not protected by the first mask 56 is removed. A suitable ratio of the second medium 54 etch rate to the first medium 52 etch rate includes ratios greater than 4:1, 6:1, 8:1, 10:1, 15:1, 20:1, 35:1 or 50:1.

A second mask 56 is formed over the first ridge 60 to provide the optical component precursor 50 of FIG. 5G and FIG. 5H. FIG. 5G is a top view of the optical component precursor 50 and FIG. 5H is a cross section of the optical component precursor 50 shown in FIG. 5G taken at the line labeled A. The second mask 56 is formed over the region of the optical component precursor 50 where the primary ridge 24 is to be formed. Accordingly, the second mask 56 tapers to a narrow region 30. At least a portion of the second mask 56 extends beyond the narrow region 30 without tapering. Additionally, the second mask 56 protects the first ridge 60. A suitable second mask 56 includes, but is not limited to, a photoresist mask and a polyimide mask.

A portion of the first medium 52 is removed and the second mask 56 removed to provide the optical component precursor 50 shown in FIG. 5I and FIG. 5J. FIG. 5I is a top view of the optical component precursor 50 and FIG. 5J is a cross section of the optical component precursor 50 shown in FIG. 5I taken at the line labeled A. The portion of the first medium is removed so as to form a second ridge 62 in the first medium 52. The second ridge 62 serves as the primary ridge 24 discussed above. In some instances, the portion of the first medium 52 is removed to the level of the second medium 54. Accordingly, the first medium 52 can be removed so as to expose the second medium 54.

A suitable method for removing the portion of the first medium 52 includes, but is not limited to, performing a second etch on the first medium 52. In some instances, the second etch is selected to etch the first medium 52 at a faster rate than the second medium 54. For instance, the second etch can etch silicon at a faster rate than silica. When the second etch etches the first medium 52 at a faster rate than the second medium 54, the second etch slows once the second medium 54 is reached. Accordingly, the second etch can be continued beyond when the second medium 54 is reached without removing a large portion of the second medium 54. Continuation of the second etch can ensure that the portion of the first medium 52 that is not protected by the second mask 56 is entirely removed. A suitable ratio of the first medium 52 etch rate to the second medium 54 etch rate includes ratios greater than 4:1, 6:1, 8:1, 10:1, 15:1, 20:1, 35:1 or 50:1.

The remainder of the first medium 52 is converted to the second medium 54 to provide the optical component 10 shown in FIG. 5K and FIG. 5L. FIG. 5K is a top view of the optical component 10 and FIG. 5L is a cross section of the optical component 10 shown in FIG. 5K taken at the line labeled A. The optical component 10 illustrated in FIG. 5K and FIG. 5L is the optical component 10 illustrated in FIG. 1A through FIG. 1E.

The method illustrated in FIG. 5A through FIG. 5L can be adapted to form other embodiments illustrated above. For instance, the first etch can be selected to round the sides of the secondary ridge 26 of FIG. 4A through FIG. 4C. One technique for forming rounded edges is to change the chemical composition of the etching plasma during the first etch. For instance, the ratio of the plasma components can be changed during the first etch.

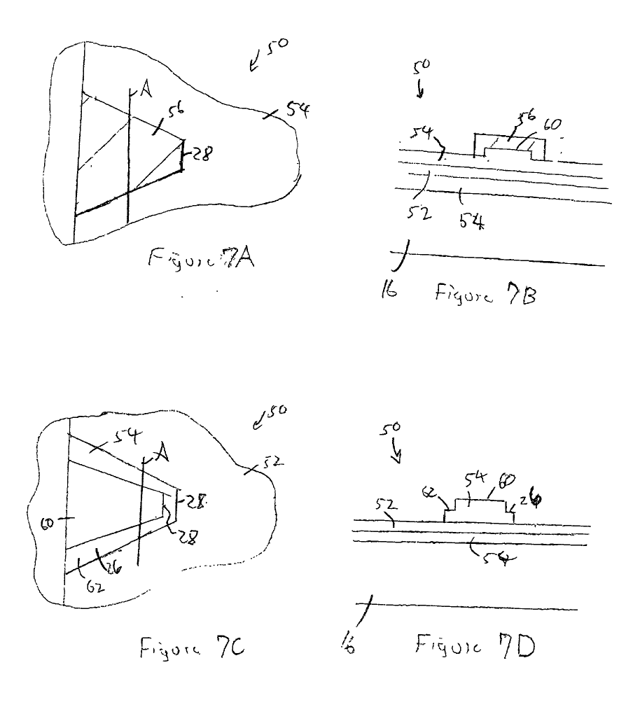

FIG. 6A through FIG. 6D illustrate the method of FIG. 5A through FIG. 5L adapted to form the optical component 10 of FIG. 3A through FIG. 3D. FIG. 6A is a top view of an optical component precursor 50 after the first portion of the first medium 52 is converted to the second medium 54 and the first mask 56 is formed on the second medium 54. The first mask 56 protects the location where the first ridge 60 is to be formed and extends over the location where the ridge of the expanded waveguide 42 is to be formed.

FIG. 6B through FIG. 6D illustrate the optical component precursor 50 after the portion of the second medium is removed and the first mask 56 is removed. FIG. 6B is a top view of the optical component precursor 50. FIG. 6C is a cross section of the optical component precursor 50 shown in FIG. 6B taken at the line labeled A and FIG. 6D is a cross section of the optical component precursor 50 shown in FIG. 6B taken at the line labeled B. The second mask 56 is formed over the region of the optical component precursor 50 where the primary ridge 24 is to be formed. Accordingly, the second mask 56 tapers to a narrow region 30. At least a portion of the second mask 56 extends beyond the narrow region 30 without tapering.

The optical component precursor 50 of FIG. 6B through FIG. 6D can be converted to the optical component 10 of FIG. 3A through FIG. 3D by removing a portion of the first medium 52 to the level of the second medium, removing the second mask 56 and converting the remaining first medium 52 to the second medium 54.

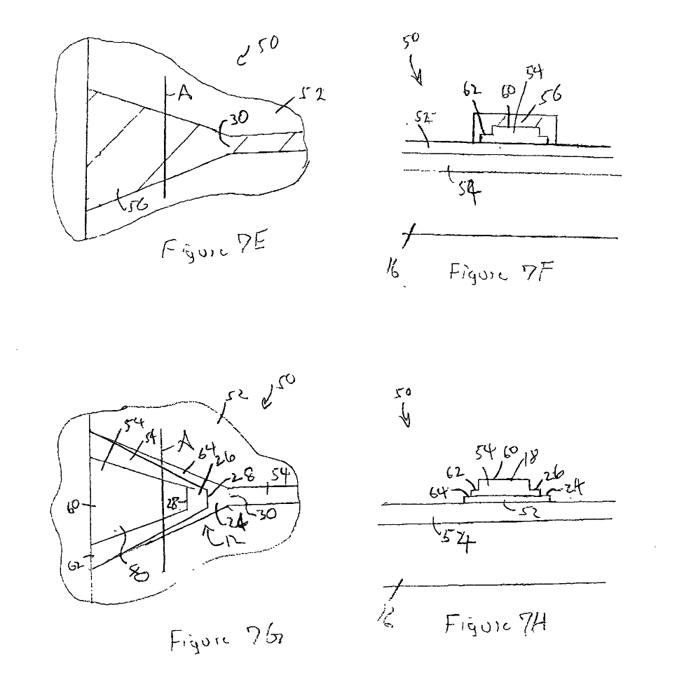

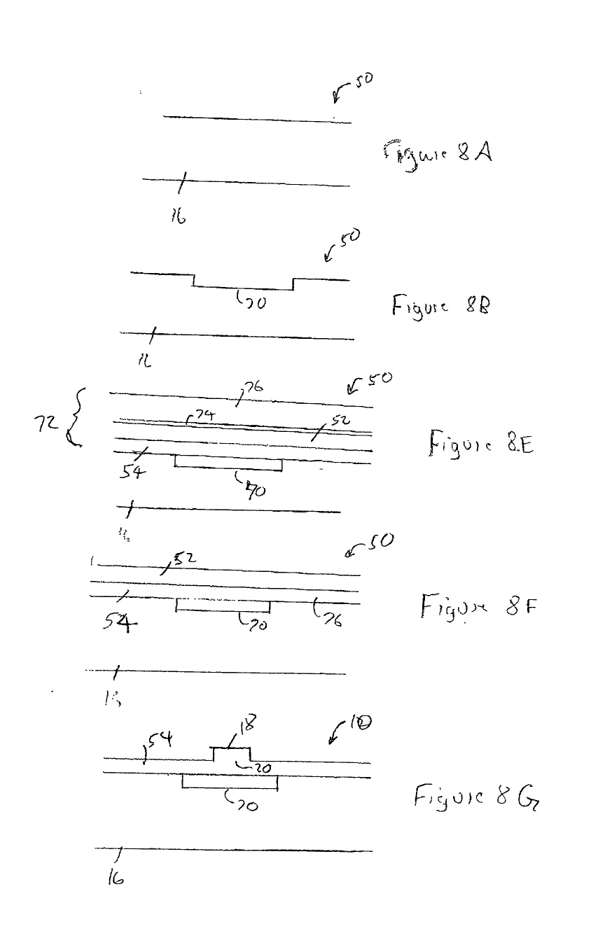

FIG. 7A through FIG. 7H illustrate the method of FIG. 5A through FIG. 5L adapted to form the optical component 10 of FIG. 2A through FIG. 2B. The method of FIG. 5A through FIG. 5F can be employed to generate an optical component precursor 50 that is suitable for use with the method of FIG. 7A through FIG. 7H. As will become evident below, the first ridge 60 of FIG. 5F serves as the tertiary ridge 40 of FIG. 2A.

A second portion of the first medium 52 is converted to the second medium 54 to provide the optical component precursor 50 of FIG. 7A and FIG. 7B. FIG. 7A is a top view of the optical component precursor 50 and FIG. 7B is a cross section of the optical component precursor 50 shown in FIG. 7A taken at the line labeled A. The method employed to convert the first portion of the first medium 52 to the second medium 54 can also be employed to convert the second portion of the first medium 52 to the second medium 54.

A second mask 56 is formed on the second medium 54 to form the optical component 10 of FIG. 7A and FIG. 7B. The second mask 56 is formed over the region of the optical component precursor 50 where the secondary ridge 26 is to be formed. Accordingly, the second mask 56 tapers to a terminal end 28 as does the secondary ridge 26. Additionally, the second mask 56 protects the first ridge 60 of FIG. 5F.

A second etch is performed to the level of the first medium 52 and the second mask 56 removed to provide the optical component precursor 50 shown in FIG. 7C and FIG. 7D. FIG. 7C is a top view of the optical component precursor 50 and FIG. 7D is a cross section of the optical component precursor 50 shown in FIG. 7C taken at the line labeled A. The second etch results in formation of a second ridge 62. The second ridge 62 serves as the secondary ridge 26 shown in FIG. 2B. The second etch is selected to etch the second medium 54 at a faster rate than the first medium 52 so the first medium 52 serves as an etch stop for the second etch. The second etch can be the same or different from the first etch employed to form the first ridge 60.

A third mask 56 is formed so as to provide the optical component precursor 50 shown in FIG. 7E and FIG. 7F. The third mask 56 is formed over the region of the optical component precursor 50 where the primary ridge 24 is to be formed. Accordingly, the third mask 56 tapers to a narrow region 30. At least a portion of the third mask 56 extends beyond the narrow region 30 without tapering. Additionally, the third mask 56 protects the first ridge 60 and the second ridge 62. A suitable third mask 56 includes, but is not limited to, photoresist and polyimide.

A third etch is performed through the first medium 52 to the level of the second medium 54 and the third mask 56 removed to provide the optical component precursor 50 shown in FIG. 7G and FIG. 7H. FIG. 7G is a top view of the optical component precursor 50 and FIG. 7H is a cross section of the optical component precursor 50 shown in FIG. 7G taken at the line labeled A. The second etch results in formation of a third ridge 64. The third ridge 64 serves as the primary ridge 24 discussed above.

The third etch is selected to etch the first medium 52 at a faster rate than the second medium 54. As a result, the interface of the second medium 54 and the first medium 52 acts as an etch stop for the third etch.

The remainder of the first medium 52 is converted to the second medium 54 to provide the optical component 10 shown in FIG. 2A through FIG. 2D. The method of FIG. 7A through FIG. 7H can be further adapted to provide an optical component 10 having a mode transformer 12 that includes more than three ridges.

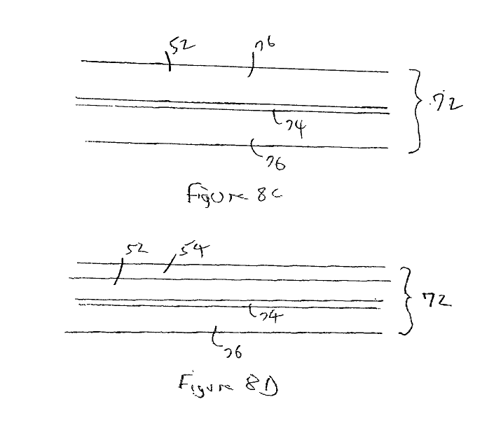

FIG. 8A through FIG. 8E illustrate a method of forming an optical component precursor 50 that is suitable for use as the optical component precursor 50 of FIG. 5A and FIG. 5B. FIG. 8A is a cross section of a base 16. A suitable base 16 includes, but is not limited to, a silicon base 16. Although the base 16 is shown as being constructed from a single material, the base 16 can have a composite construction or can be constructed with two or more layers of material.

One or more pockets 70 are formed in the base 16 as illustrated in FIG. 8B. The one or more pockets 70 can be formed with a mask and an etch or other techniques. As will become evident below, the pocket 70 is positioned under the rib 18. Accordingly, the pocket 70 is formed so the rib(s) 18 can be formed over the pocket 70 in the desired pattern.

A wafer 72 having the desired first medium 52 is obtained. The wafer 72 can be fabricated or can be obtained from a supplier. When the desired first medium is silicon, a suitable wafer includes, but is not limited to, a silicon on insulator wafer 72. As shown in FIG. 8C, a silicon on insulator wafer 72 typically includes a silica layer 74 positioned between silicon layers 76. A preliminary portion of the first medium is converted to the second medium 54 as illustrated in FIG. 8D.

Wafer bonding techniques are employed to bond the preliminary portion of the second medium 54 to the base 16 to provide the optical component precursor illustrated in FIG. 8E. The top silicon layer 76 and the silica layer 74 can be removed to provide the optical component precursor 50 shown in FIG. 8F. Additionally, a portion of the bottom silicon layer 76 can be removed to provide the first medium 52 with the desired thickness. Suitable methods for removing the silicon layer 76 include, but are not limited to, etching, buffing, polishing, lapping, detachment through H implantation and subsequent annealing. Silicon remains as the first medium 52.

The method described in FIG. 5A through FIG. 5L can be employed to form a rib 18 as shown in FIG. 8G. Before forming the first medium 52 on the base 16, air can be left in the pockets 70 or another material such as a low index of refraction material can be deposited in the pockets 70. The material in the pocket 70 is positioned adjacent to the light signal carrying region 20. As a result, the material in the pocket 70 is selected to reflect light signals from the light signal carrying region 20 back into the light signal carrying region 20.

Although the above illustrations show the rib 18 including the mode transformer 12 attached to one or more straight waveguides, the rib 18 can include only the mode transformer 12.

As noted above, particular etches can be selected so as to etch the second medium faster than the first medium. An example of a suitable etch for etching silica faster than silicon is a plasma dry etch employing an etching medium that includes etching gases such as CF₄ and/or C₂F₆; polymerizing gases such as CHF₃, CH₂F₂, C₄F₈, CO and/or C₄F₆; and Noble gases such as Ar, Xe and/or He. In one example, the etching medium includes CF₄, CHF₃ and Ar. When the etching medium is applied to the optical component at a temperature of about 15° C., at a pressure of 100-300 mTorr and at a CF₄:CHF₃ ratio of about 1:3, the etching medium will etch silica at about 10 to 20 times faster than silicon and will etch silica at about 2000-5000 A/minute. The selectivity for a second medium such as silica can generally be changed by changing the ratio of CF₄:CHF₃. For instance, decreasing the ratio of CF₄:CHF₃ generally increases the selectivity of the etching medium for silica.

Other etches are selected so as to etch the first medium faster than the second medium. An example of a suitable etch for etching silicon faster than silica is a plasma dry etch employing an etching medium that includes HBr and O₂. When the etching medium is applied to the optical component at a temperature of about 10-50 ° C., at a pressure of 30-100 mTorr and at a HBr:O₂ ratio of about 50:1, the etching medium will etch silicon at about 50 times faster than silica and will etch silicon at about 200-500 A/minute. The selectivity for the second medium (silica) can generally be changed by changing the ratio of HBr:O₂. For instance, decreasing the ratio of HBr:O₂ generally increases the selectivity of the etching medium for silica. A faster etch chemistry can be employed to etch the bulk of the first medium. When the interface of the first medium and the second medium is approached, the HBr:O₂ ratio can be changed to provide a slower etch rate with a selectivity.

Although the methods described above are described in the context of forming a mode transformed, the methods can be adapted to form other portions of an optical component such as waveguides and star couplers.

Other embodiments, combinations and modifications of this invention will

occur readily to those of ordinary skill in the art in view of these teachings. Therefore, this invention is to be limited only by the following claims, which include all such embodiments and modifications when viewed in conjunction with the above specification and accompanying drawings.

1. A method of forming an optical component, comprising:
converting a portion of a first medium to a second medium, the first medium being included in an optical component precursor having the first medium positioned over a base; and
removing a portion of the second medium so as to form a ridge in the second medium.

2. The method of claim 1, wherein converting the portion of the first medium includes performing a thermal oxidation.

3. The method of claim 1, wherein removing the portion of the second medium includes performing an etch that etches the second medium at a rate of at least four times faster than the first medium.

4. The method of claim 1, wherein removing the portion of the second medium includes performing an etch that etches the second medium at a rate of at least eight times faster than the first medium.

5. The method of claim 1, wherein the ridge tapers to a terminal end.

6. The method of claim 1, further comprising:
forming a mask so as to protect the ridge.

7. The method of claim 6, wherein the mask tapers to a narrow region and a portion of the mask extends beyond the narrow region without tapering.

8. The method of claim 6, further comprising:
removing at least a portion of the first medium so as to form a second ridge in the first medium.

9. The method of claim 8, wherein the portion of the first medium is removed so as to expose second medium located between the base and the first medium.

10. The method of claim 8, wherein removing the portion of the first medium includes performing an etch that etches the first medium at a rate of at least four times faster than the second medium.

11. The method of claim 8, wherein removing the portion of the first medium includes performing an etch that etches the first medium at a rate of at least eight times faster than the second medium.

12. The method of claim 8, wherein the second ridge is positioned under the first ridge.

13. The method of claim 8, wherein the removed portion of the first medium is exposed by removing the portion of the second medium.

14. The method of claim 1, wherein a second medium is positioned between the base and the first medium.

15. The method of claim 14, further comprising:
bonding a wafer having the first medium and the second medium to the base such that the second medium is bonded to the base.

16. The method of claim 1, further comprising:
converting a second portion of the first medium to a second medium.

17. The method of claim 16, further comprising:
removing a second portion of the second medium so as to form a second ridge in the second medium.

18. The method of claim 17, wherein the second ridge is positioned under the first ridge.

19. The method of claim 18, wherein at least a portion of the first ridge is narrower than the second ridge.

20. The method of claim 11, wherein the second ridge tapers to a terminal end.

21. The method of claim 1, wherein the first medium is silicon and the second medium is silica.

22. A method of forming an optical component, comprising:
obtaining a wafer having a first medium;
converting a preliminary portion of the first medium to a second medium; and
bonding the wafer to a base such that the converted second medium is bonded to the base.

23. The method of claim 22, further comprising:
converting a first portion of the first medium to the second medium such that first medium is positioned between the preliminary portion and the first portion.

24. The method of claim 22, further comprising:
removing a portion of the second medium to the first medium so as to form a ridge in the second medium.

25. The method of claim 22, wherein the wafer includes material adjacent to the first medium and further comprising:
removing the material from the wafer so as to expose the first medium.
